(19) United States
(12) Patent Application Publication
(10) Pub. No.: US 2018/0307326 A1
(43) Pub. Date: Oct. 25, 2018

(54) COMMUNICATING BRACELET

(71) Applicants: Gad BENETT, Rehovot (IL); Matania HOGGEG, Misgav Dov (IL)

(72) Inventor: Matania HOGGEG, MISGAV DOV (IL)

(73) Assignee: Gad BENETT, REHOVOT (IL)

(21) Appl. No.: 15/763,922

(22) PCT Filed: Oct. 5, 2016
(86) PCT No.: PCT/IL2016/051078

§ 371 Date: Mar. 28, 2018

Related U.S. Application Data
(60) Provisional application No. 62/237,689, filed on Oct. 6, 2015.

(51) Int. Cl. G06F 3/023; G06F 3/02; G06F 1/16; A44C 5/00

(52) U.S. Cl. CPC G06F 3/023; G06F 3/0202; A44C 5/0007; G06F 1/1684; G06F 1/163

(57) ABSTRACT

A communicating bracelet that can communicate with a coupled electronic device. The bracelet has one or more actionable buttons. When the bracelet is worn at a palm-position, an annex-portion of the bracelet is worn across the wrist, going across the palm and between the thumb and the index finger. The actionable buttons can be operated by the fingers of the same hand where the bracelet is worn. Each actionable button manipulation can be associated with an instruction sent to the coupled device.

### TECHNICAL FIELD

The present invention relates to wearable objects with communication features in general, and in particular to bracelet with wireless communications capabilities.

### BACKGROUND ART

The mobile phone has become an important function in the everyday life of many people, and can many more task than simply talking with another telephone. Some of the usages of a mobile phone include: listening to music, taking pictures and videos, navigation etc. The mobile phone can also be used as a remote controller to operate other devices such as a television, projector, air-conditioning units and many other devices.

Most of the time, a user operates the mobile phone directly by holding the phone in one hand and operating the phone either with the same hand that's holding the phone (typically by the thumb of the holding hand), or by the other hand (one hand holding the phone, the other hand operating the phone).

In some contexts, a user may wish to use a function of the mobile phone quickly without accessing the mobile phone directly. For example, when jogging while listening to music if the user wishes to change songs (say next song on the playlist), normally the user has to stop jogging in order to access the phone and change songs.

Different wearable products exist or are in development today to enable the user to operate some of the mobile phone functions. Some of these products include: smart watches, rings and dedicated buttons.

The smart watch is worn on the hand like a regular watch and can connect to a smart phone wirelessly. The smart watch is operated via a touchscreen and/or dedicated buttons which activate and operate mobile applications and functions. Using the smart watch requires the user to use the other hand and have eye contact with the watch.

Rings are another category of wearable communicating devices. Typically, the user needs to press a button on the ring and perform a gesture that is understood by an application on the mobile phone.

There are some dedicated buttons, like one that is attached to the mobile phone's headphone entry, and pressing this button activates a preprogrammed function at the mobile device.

### SUMMARY OF INVENTION

It is an object of the present invention to disclose a bracelet that communicates with a coupled electronic device.

It is another object of the present invention to disclose a bracelet that communicates with a mobile phone.

It is a further object of the present invention to disclose a bracelet that can be operated by a finger.

It is yet another object of the present invention to disclose a bracelet that can be operated by a finger of the same hand where the bracelet is worn.

It is yet a further object of the present invention to disclose a bracelet that can be operated by a finger of the same hand where the bracelet is worn without eye-contact between the user and the button.

The present invention relates to a communicating bracelet for operating a coupled device, comprising:

(i) a base-portion adapted to be worn on the wrist;

(ii) an annex-portion connected to the base-portion and adapted to be worn in a palm position across the palm between the thumb and the index finger, the annex-portion comprising one or more actionable buttons;

(iii) a communication unit connected to said one or more actionable buttons comprising a power source and a wireless transmission module,

wherein when a button of said one or more actionable button is manipulated by the user, an instruction associated with said manipulation is transmitted by the wireless transmission unit to the coupled device.

In some embodiments, the coupled device is a mobile phone, a television set, a game console, a projector, an air-conditioning unit, an amplifier, a set-top box, a cable box, a DVD player, an IR input unit, a smart home unit, or an Internet of Things (IoT) device.

In some embodiments, the wireless transmission unit communicates with the coupled device via the Bluetooth protocol, Infra-Red (IR), Near Field Communication (NFC) or any other wireless communications technology.

In some embodiments, the annex-portion can also be worn on the wrist.

In some embodiments, the communicating bracelet is automatically turned on when the annex-portion is moved to the palm position.

In some embodiments, the communicating bracelet initiates a connection to the coupled device when the communicating bracelet is turned on.

In some embodiments, the communication bracelet comprises 2 or 3 actionable buttons.

In some embodiments, an actionable button can be manipulated by touching the button, touching the button twice within a predetermined time, pressing the button, pressing the button twice within a predetermined time, pressing the button for predefined periods of time, moving the button, twisting the button, sliding the button or any combination thereof.

In some embodiments, more than one actionable button are manipulated simultaneously.

In some embodiments, an action button is manipulated by a finger of the same hand where the annex-portion is worn.

In some embodiments, the annex-portion is made of elastic materials.

In some embodiments, the elastic materials comprise, silicon, rubber, plastics, textile or any combination thereof.

In some embodiments, the annex-portion size is adjustable to fit different sizes of palms.

In some embodiments, the position of one or more actionable buttons on the annex-portion is configurable.

In some embodiments, the instruction performs an action on the coupled device.

In some embodiments, the action on the coupled device is to send an instruction to an auxiliary device.

In some embodiments, the auxiliary device is a television set, a projector, an air-conditioning unit, an amplifier, a set-top box, a cable box, a DVD player or an IR input unit.

In some embodiments, the entire communication unit is attached to the annex-portion.

In some embodiments, the communication unit comprises an adjustment mechanism to adjust its position on the annex-portion.

In some embodiments, the communicating bracelet further comprises one or more LED's.

In some embodiments, the further comprises a vibrator.

In some embodiments, the power source is a replaceable battery or a rechargeable power source.

In some embodiments, the communication unit is placed entirely on the base-portion or part on the base-portion and part on the annex-portion.

In some embodiments, the annex-portion is connected to the base-portion in at least two spots, and the annex-portion is stretched across the thumb to move to the palm position.

In some embodiments, when moving the annex-portion to the palm position, the annex-portion is disconnected from the base-portion in one end, moved across the wrist and then connected again to the base-portion.

In some embodiments, the communicating bracelet is adapted to be worn either on the left hand or the right hand.

In some embodiments, the communicating bracelet is a shirt with a hole at the end of a sleeve.

### BRIEF DESCRIPTION OF DRAWINGS

FIGS. 1A-1B show an embodiment of the communicating bracelet in the wrist position. FIG. 1A showing the bracelet on its own, and FIG. 1B showing the bracelet worn on a hand, in the wrist position.

FIG. 2 shows an embodiment of the communicating bracelet in palm position where the annex-portion of the bracelet is worn across the wrist. The user can press on an action-button with the same hand where the bracelet is worn.

FIG. 3 shows an embodiment the communicating bracelet in the palm position where the communication unit's position on the annex-portion can be adjusted.

FIG. 4 shows an embodiment the communicating bracelet where the annex-portion can be detached at one end.

FIG. 5 shows the bracelet of FIG. 4 where the user detaches one end of the annex-portion in order to wrap it around the wrist and then attach it again to the base-portion.

FIG. 6 shows an embodiment the communicating bracelet where the base-portion is a shirt.

### MODES FOR CARRYING OUT THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The present invention relates to a communicating bracelet that can communicate with a coupled electronic device. The bracelet has one or more actionable buttons. When the bracelet is worn at a palm-position, an annex-portion of the bracelet is worn across the wrist, going across the palm and between the thumb and the index finger. The actionable buttons can be operated by the fingers of the same hand where the bracelet is worn. The user can operate the bracelet's buttons without looking at them. This means that when the bracelet is worn in the palm position, the user may use both his hands freely and does not need to look at the bracelet to operate it.

The communicating bracelet can be wirelessly connected to an electronic device. After connection, the communicating bracelet can send instructions to the coupled electronic device. The coupled electronic device is typically a mobile phone, but it can also be other devices that can operated wirelessly such as a television set, a game console, a cable box, a set-top box, an air-conditioning unit, a projector, units of a car etc.

The bracelet of the invention comprises two portions: a base-portion and an annex-portion. The base-portion is adapted to be worn on the wrist. The annex-portion which is connected to the base portion, can be either worn on the wrist (wrist mode) or moved into the palm of the hand (palm mode). In some embodiments, the annex-portion can always remain in the palm-position and not folded back into a wrist position.

The bracelet's communication unit comprises a power source and a wireless transmission module. The power source can be any sort of battery and can be either a replaceable battery (like in a wrist watch) or it can be a rechargeable battery. The rechargeable battery can be either removed from the bracelet to be recharged in a separate charging device or in some embodiments the battery can be recharged while inside the bracelet.

The transmission module of the bracelet can communicate with the coupled device via the Bluetooth protocol, Infra-Red (IR), Near Field Communications (NFC) or any other present or future wireless communications protocol.

The communication unit is connected to the one or more actionable buttons on the annex-portion of the bracelet.

In some embodiments, the communicating bracelet has several operational modes such as ON, OFF and dormant in order to save on battery power as some communication protocols such as Bluetooth can consume significant amount of energy for devices with limited battery power. In the ON position the bracelet is in communication with the couple device and ready to send instructions. In the OFF position the bracelet is completely turned off, and no action can be performed until the bracelet is first turned on. In a dormant position, the bracelet is not connected to the coupled device, but can the bracelet is ready to act upon user input, for example, only connecting to the coupled device after a first user action.

The second portion of the communicating bracelet is an annex-portion connected to the base-portion. The annex-portion is adapted to be worn either in a wrist position worn entirely on the wrist or in a palm position worn one part on the wrist and the other part on the palm between the thumb and the index finger. The annex-portion has one or more actionable buttons. When an actionable button is manipulated by the user (touching, pressing, double pressing, long press, moving, sliding etc.) a predetermined command (instruction) associated with the manipulation is transmitted to the coupled device. Example of such commands comprise, increase volume, decrease volume, next song, previous song, answer a call, reject a call, send out one or more emergency messages etc.

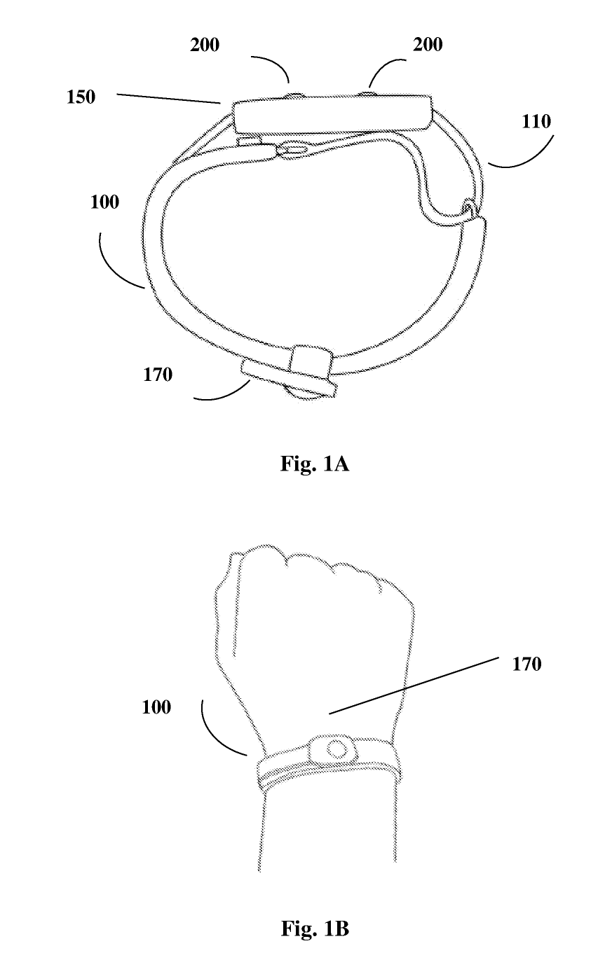

Reference is now made to FIG. 1A showing the communicating bracelet in the wrist position. The base-portion 100 and the annex-portion 110 are connected and in the wrist position the annex-portion 110 is placed (fully or partially) on top (or below) the base-portion 100 so the communicating bracelet looks like a regular bracelet (roughly a generally tubular bracelet shape). In this embodiment, the entire communication unit 150 is attached to the annex-portion 110. The communication unit 150 comprises a power source and a wireless transmission module. It is also possible for the communication unit 150 to be entirely attached to the base-portion 100 or be placed on both the base-portion 100 and the annex-portion 110.

In some embodiments, as shown in FIG. 1A, the communication unit 150 is directly connected to one or more actionable buttons 200. The one or more actionable buttons 200 are always placed on the annex-portion 110 but it is possible for the communication unit 150 to be placed on other locations on the bracelet and be connected to the one or more actionable buttons 200 via wires.

The base-portion 100 can have an adjustment mechanism 170 for adjusting the size of the base-portion 100 for different wrist sizes.

FIG. 1B shows the wrist position of FIG. 1A worn on a wrist.

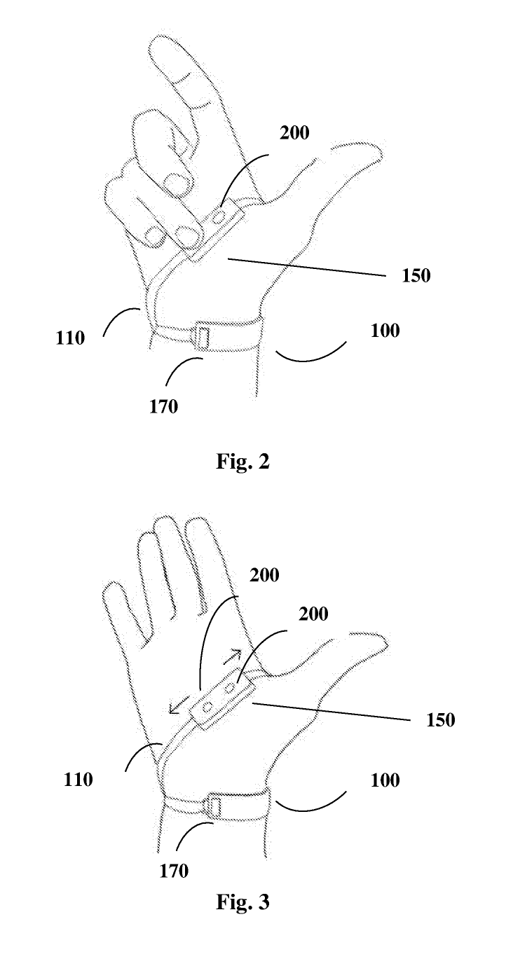

Reference is now made to FIG. 2 showing the communicating bracelet with the annex-portion 110 in the palm position. In the palm position, the annex-portion 110 is placed across the palm, going through between the thumb and the index finger. The one or more actionable buttons 200 are adapted to be preferably positioned above the thenar eminence area. The “thenar eminence” refers to the group of muscles on the palm of the human hand at the base of the thumb. FIG. 2 shows the user pressing an actionable button 200 with his ring finger. The user can actually press an actionable button without looking at it. The term “press” refers to any manipulation of an actionable button 200 such as a press, a long press, double click, sliding, moving etc.

FIG. 2 shows a communicating bracelet with actionable buttons 200 two (one visible, one not visible and being pressed), though other embodiments may have only one actionable button 200, three actionable buttons 200 or more.

Reference is now made to FIG. 3 showing an embodiment where the position of the actionable buttons 200 can be adjusted up and down the annex-portion 110 (shown the two arrows). In the embodiment shown in FIG. 3, the actionable buttons 200 are connected to the communication unit 150 which includes an adjustment mechanism such as a slider so that it can be moved across the annex-portion 110 so that each user can adjust it to the position most comfortable for him.

Typically, the annex-portion 110 comprises 1, 2 or 3 actionable buttons 200.

The actionable buttons 200 can be manipulated by touching the button 200, touching the button 200 twice within one second (or any predetermined time for a “double click” action), pressing the button 200, pressing the button 200 twice within one second, pressing the button 200 for predefined periods of time, moving the button 200, twisting the button 200, sliding the button 200 or any combination thereof. In some embodiments, one or more actionable buttons 200 is programmed to recognize different manipulations by the user, each manipulation programmed to correspond to an action the user wishes to perform on the coupled device.

The invention encompasses different types of actionable buttons 200. Some buttons 200 can be operated like a computer mouse button, recognizing actions such as but not limited to a click, a double click or a long press. Some buttons 200 can be operated like a touch surface, again recognizing actions such as but not limited to a click, a double click or a long press. Some buttons 200 can be operated like a joy stick recognizing actions such as but not limited to twisting to different directions and optionally pressing it. Some buttons 200 can be operated like a slider recognizing actions such as but not limited to moving the button to one or the other side and optionally pressing it. Some buttons 200 can also recognize pressure, for example, pressing the button for over a predetermined time can be a different action than pressing and releasing the button immediately. It is not necessary for all the actionable buttons 200 on the annex-portion 110 to be of the same type. The same annex-portion 110 may have different actionable buttons 200, for example, on central “joystick-like” button 200 and two other “touch-surface like” buttons 200 on each side. It is also possible to have actions associated with manipulating more than one button 200 simultaneously, for example, pressing two buttons 200 simultaneously.

It is important to note that an action button 200 is typically manipulated by a finger of the same hand where the annex-portion 110 is worn as shown in FIG. 2. This enables the user to manipulate the action buttons 200 with one hand, without need to look at the annex-portion 110. When not manipulating the action buttons 200 the user has both his hands free to carry any normal task. When manipulating an action button 200 the user does not need to turn his eyes to the annex-portion 110 as he can find the location of an action button 200 instinctively just by bending the finger inside the palm (in a movement similar to pressing a guitar string). This can be very useful in many situations. For example, if an action button 200 is programmed to move to the next song in a playlist, then when jogging, it is not safe for a runner to look at the annex-portion 110 while running, and the runner does not want to stop running in order to stand still, look at the annex-portion 110 and manipulate an action button 200.

In some embodiments, the communicating bracelet is activated (“ON” mode) when the annex-portion 110 is moved to palm position. This effect can be achieved, for example, by two magnets one on the annex-portion 110 and the other on the base-portion 100. When the annex-portion 110 is moved from the wrist-position to the palm-position, the two magnets are separated, an action easily detectable, for example, if the two magnets were part of an electric circuit which is broken when the magnets are no longer in contact. In some embodiments, the communicating bracelet is activated by a dedicated switch, button or similar unit on the base-portion 100 or annex-portion 110 or communication unit 150.

The action buttons 200 are programmed to recognize different manipulations, wherein each manipulation is associated with an action the user wishes to perform on the coupled device. An action button 200 can be associated with a single manipulation (i.e. only pressing it is recognized) or the action button 200 can be associated with a plurality of manipulations (i.e. “click”, “double-click”, long press etc.), each distinct manipulation is then associated with a different action the user wishes to perform on the coupled device.

The action buttons 200 can come with default actions associated with each distinct manipulation. In some embodiments, an application of the invention on a coupled mobile device (such as a mobile phone) can reprogram each distinct, recognizable manipulation to perform a different action as chosen by the user. In some embodiments, an Application Program Interface (API) enables 3^{rd} party application developers to include code in 3^{rd} party applications to reprogram one or more distinct manipulation of an action button 200 to an action offered by that 3^{rd} party application.

The annex-portion 100 is preferably made of elastic materials, including but not limited to silicon, rubber, plastics, textile or any combination thereof.

The annex-portion 100 size is adjustable to fit different sizes of palms. Size adjustment can be achieved in any way of the art, for example, like a wrist watch strap. The communicating bracelet can be worn either on the left hand or on the right hand.

In some embodiments, the position of one or more actionable buttons 200 on the annex-portion 100 is configurable, that is the buttons 200 can be moved to different locations along the annex-portion 100 in order to better fit user preferences and physiology.

In some embodiments, manipulating an action button 200 results in a feedback returned to the user, as to acknowledging that the manipulation was well received by the system. The feedback may be provided by the communicating bracelet itself, for example, by vibrating, turning on a light (such as a LED), making a sound etc. Alternatively, it is also possible to provide the feedback via the coupled mobile device, for example, producing a confirmation sound on the coupled mobile phone.

The communicating bracelet can perform an action directly on the coupled device. For example on a mobile phone, actions can include moving songs in a playlist (i.e. Forward or Backward), playing/pausing a song, taking a photo, starting to shoot a video, pausing/ending the video shoot, increasing/lowering volume, making a phone call to a given number (for example police or physician), answering a call, terminating a call, rejecting an incoming call etc.

In addition, sometimes a mobile phone can operate auxiliary devices including but not limited to a television set, a game console, a projector, an air-conditioning unit, an amplifier, a set-top box, a cable box, a DVD player, an IR input unit, a smart home unit, or any device equipped with wireless communications such as all Internet of Things (IoT) devices. The communicating bracelet of the invention can thus be used to send an instruction to the mobile phone, where the instructions perform an action by the mobile phone on the auxiliary device.

In some embodiments, the communicating bracelet communicates directly with any device equipped with wireless technology, for example, a television set, a game console, a projector, an air-conditioning unit, an amplifier, a set-top box, a cable box, a DVD player, an IR input unit, a smart home unit, or any device equipped with wireless communications such as all Internet of Things (IoT) devices.

In some embodiments, the annex-portion 110 is always in the palm position and never folds back into the base-portion 100 thus the communicating bracelet only has a palm position.

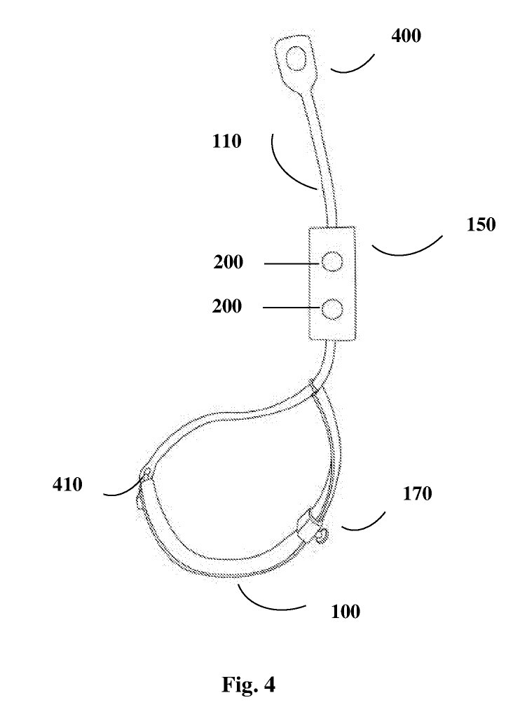

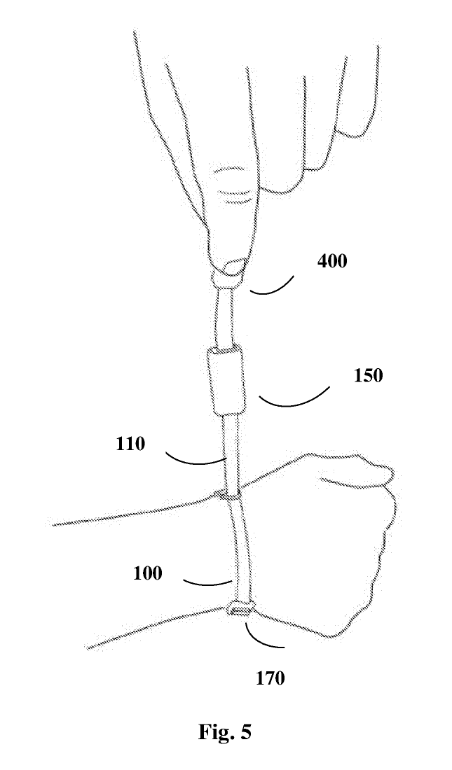

FIGS. 4-5 show an embodiment of a communicating bracelet where the annex-portion 110 is can be disconnected from the base-portion 100 at one end when moving from the wrist position to the palm position. The annex-portion 110 comprises a locking mechanism 400 at the disconnected end that is adapted to connect to the base-portion 100 on connector 410 after being passed across the wrist to the palm position. The locking mechanism 400 and its connector 410 can be any locking mechanism known in the art such as two magnets, a locking mechanism 400 with a hole (as shown in FIG. 4) being placed on a connector 410 with a bulge where the hole has to squeeze the bulge a bit to fit and thus remains connected. FIG. 5 shows the annex-portion 110 open before being passed across the wrist to the palm position.

In some embodiments, the annex-portion 110 is never disconnected from the base-portion 100 and is stretched when moved to the palm position.

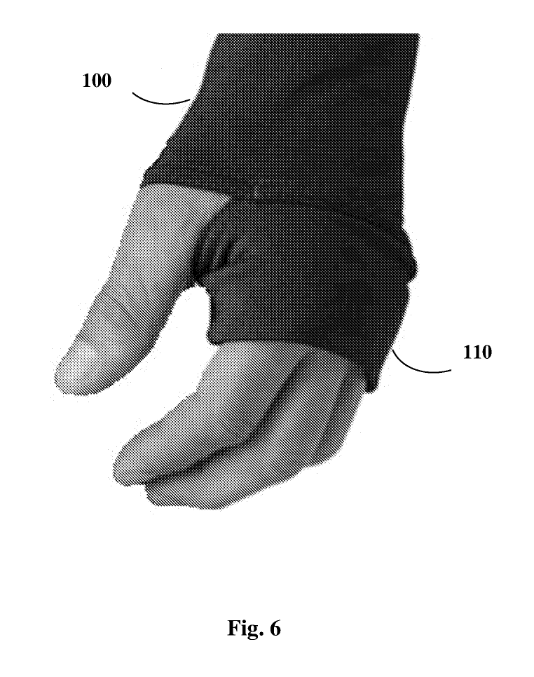

FIG. 6 shows an embodiment the communicating bracelet where the base-portion is a shirt with a hole at the end of the sleeve. The user has the option to insert the thumb in the hole and adopting a palm position. In this embodiment, the shirt comprises wireless communications technology and pressing action buttons 200 on the palm side (not shown) sends predefined instructions to a coupled device.

Use Cases

The following cases illustrate some examples of instructions associated with action buttons activating functions on a mobile phone. Each action is associated with a particular manipulation of one (or more) action buttons 200:
1. Alert—activating a mobile application alerting/reporting process. The alerting process can send messages (SMS and/or Instant Messages for example) to one or more preconfigured contacts. The alerting process may also initiate one or phone calls to a predetermined contacts or law authorities. The alerting process can communicate the user's location, take pictures, videos, and record sound all to be communicated to the people receiving the messages and/or calls. Pictures, video and sound may be communicated via a link to a predefined storage location (for example on the cloud). The alert function may be used by:
   older population
   kids and youth
   population with medical conditions (diabetes, epileptic, heart attack, stroke etc.)
   military/security
   joggers, hikers etc.
2. Call management—answering a call, reject an incoming call, mute, volume adjustment, auto text messaging etc.
3. Music and movies—play/pause, forward/backward, practical while doing additional activity i.e. sports, driving, teaching.
4. Presentations—managing slides, video, links during presentation while speaking and keep hands free and eye contact.
5. Camera—remote picture on chosen time of own (“selfy”) or distant location, play, record, pause, or stop video.
6. “Smart house”—activation of various advanced home technologies. The bracelet will enable identification of the user within the house and will adjust to his set preferences per location.
7. Military and Security needs—remote activation of security devices (i.e. PTT, cameras, lights), reporting location, call for backup.
8. Handicap population—management of different applications with minimal physical activity.
9. Incoming call message alert from a predetermined contact—when receiving a call or message from a predetermined contact the communicating bracelet can vibrate (in a predetermined vibration pattern). This is practical, for example, when entering a meeting with the phone in quiet mode, but needing to monitor receiving an important call or message from a predetermined contact.

Although the invention has been described in detail, nevertheless changes and modifications, which do not depart from the teachings of the present invention, will be evident to those skilled in the art. Such changes and modifications are deemed to come within the purview of the present invention and the appended claims.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” means any one or more microprocessors, central processing units (CPUs), computing devices, microcontrollers, digital signal processors, or like devices.

The term “computer-readable medium” refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

1. A communicating bracelet for operating a coupled device, comprising:
(i) a base-portion adapted to be worn on the wrist;
(ii) an annex-portion connected to the base-portion and adapted to be worn in a palm position across the palm between the thumb and the index finger, the annex-portion comprising one or more actionable buttons;
(iii) a communication unit connected to said one or more actionable buttons comprising a power source and a wireless transmission module,
wherein when a button of said one or more actionable button is manipulated by the user, an instruction associated with said manipulation is transmitted by the wireless transmission unit to the coupled device.

2. The communicating bracelet according to claim 1, wherein the coupled device is a mobile phone, a television set, a game console, a projector, an air-conditioning unit, an amplifier, a set-top box, a cable box, a DVD player, an IR input unit, a smart home unit, or an Internet of Things (IoT) device.

3. The communicating bracelet according to claim 1, wherein the wireless transmission unit communicates with the coupled device via the Bluetooth protocol, Infra-Red (IR), Near Field Communication (NFC) or any other wireless communications technology.

4. The communicating bracelet according to claim 1, wherein the annex-portion can also be worn on the wrist.

5. The communicating bracelet according to claim 1, wherein the communicating bracelet is automatically turned on when the annex-portion is moved to the palm position.

6. The communicating bracelet according to claim 5, wherein the communicating bracelet initiates a connection to the coupled device when the communicating bracelet is turned on.

7. The communicating bracelet according to claim 1, comprising 2 or 3 actionable buttons.

8. The communicating bracelet according to claim 1, wherein an actionable button can be manipulated by touching the button, touching the button twice within a predetermined time, pressing the button, pressing the button twice within a predetermined time, pressing the button for predefined periods of time, moving the button, twisting the button, sliding the button or any combination thereof.

9. The communicating bracelet according to claim 8, wherein more than one actionable button are manipulated simultaneously.

10. The communicating bracelet according to claim 8, wherein an action button is manipulated by a finger of the same hand where the annex-portion is worn.

11. The communicating bracelet according to claim 1, wherein the annex-portion is made of elastic materials.

12. (canceled)

13. The communicating bracelet according to claim 1, wherein the annex-portion size is adjustable to fit different sizes of palms.

14. The communicating bracelet according to claim 1, wherein the position of one or more actionable buttons on the annex-portion is configurable.

15. The communicating bracelet according to claim 1, wherein the instruction performs an action on the coupled device.

16. (canceled)

17. (canceled)

18. The communicating bracelet according to claim 1, wherein the entire communication unit is attached to the annex-portion.

19. The communicating bracelet according to claim 1, wherein the communication unit comprises an adjustment mechanism to adjust its position on the annex-portion.

20. (canceled)

21. (canceled)

22. (canceled)

23. The communicating bracelet according to claim 1, wherein the communication unit is placed entirely on the base-portion or part on the base-portion and part on the annex-portion.

24. The communicating bracelet according to claim 1, wherein the annex-portion is connected to the base-portion in at least two spots, and the annex-portion is stretched across the thumb to move to the palm position.

25. The communicating bracelet according to claim 1, wherein when moving the annex-portion to the palm position, the annex-portion is disconnected from the base-portion in one end, moved across the wrist and then connected again to the base-portion.

26. The communicating bracelet according to claim 1, adapted to be worn either on the left hand or the right hand.

27. (canceled)
